(19) United States
(12) Patent Application Publication
(10) Pub. No.: US 2008/0073991 A1
(43) Pub. Date: Mar. 27, 2008

(54) BEARING ASSEMBLY FOR COOLING FAN

(75) Inventors: WUN-CHANG SHIH, Tu-Cheng (TW); QIANG ZHANG, Shenzhen (CN); CHIN-JUNG CHEN, Tu-Cheng (TW); YING-LIANG LI, Shenzhen (CN); RUI-JUN HUANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., Tu-Cheng (TW)

(21) Appl. No.: 11/556,519

(22) Filed: Nov. 3, 2006

(30) Foreign Application Priority Data
Sep. 27, 2006 (CN) 200610062827.0

(51) Int. Cl. H02K 7/00; H02K 5/16; F04B 17/00

(52) U.S. Cl. 310/90; 310/67 R; 417/423.12

(57) ABSTRACT

A bearing assembly includes a bearing (10) having a bearing surface (16) defining a bearing hole (12) therein and a shaft (20) disposed in the bearing hole of the bearing. The bearing has an open end for the shaft insertion therethrough into the bearing hole along an axial direction of the bearing. The shaft defines a notch (24) in an outer periphery thereof, which is located corresponding to the open end of the bearing. A plurality of spiral grooves (228) are defined in the outer periphery of the shaft above the notch. A rotation direction of the shaft is the same as a spiral direction of the grooves during rotation of the shaft. A cover (50) covers the open end of the bearing and closely surrounds the grooves of the shaft.

### BACKGROUND OF THE INVENTION

1. Field of the Invention

The present invention relates to a cooling fan, and more particularly relates to a bearing assembly of the cooling fan which has good lubricating characteristics.

2. Description of related art

With continuing development of the electronic technology, electronic packages such as CPUs (central processing units) are generating more and more heat that requires immediate dissipation. Cooling fans are commonly used in combination with heat sinks for cooling CPUs.

A cooling fan generally includes a fan frame having a tube formed at a middle portion of the frame, and a bearing assembly disposed in the tube. The bearing assembly includes a bearing received in the tube and a shaft being rotatably mounted into a bearing hole of the bearing. Lubricant oil is contained in the bearing assembly to carry out lubrication between the bearing and the shaft. During operation of the fan, lubricant oil is pushed towards a top of the bearing by a pumping action generated by rotation of the shaft relative to the bearing. The oil may escape from the tube from the top end of the bearing. When this happens, a sufficient lubrication cannot be maintained between the shaft and the bearing, and friction between the shaft and the bearing is increased, which may reduce the operational life-span of the fan.

For the foregoing reasons, there is a need for a bearing assembly which has an improved capability of preventing lubricant leakage.

### SUMMARY OF THE INVENTION

The present invention relates to a bearing assembly for a rotary motor such as a fan motor or an HDD motor. According to a preferred embodiment of the present invention, the bearing assembly includes a bearing having a bearing surface defining a bearing hole therein and a shaft disposed in the bearing hole of the bearing. The bearing has an open end for shaft insertion therethrough into the bearing hole along an axial direction of the bearing. The shaft defines a notch in an outer periphery thereof, which is located corresponding to the open end of the bearing. A plurality of spiral grooves are defined in the outer periphery of the shaft above the notch along a direction opposite to an inserting direction of the shaft. A rotation direction of the shaft is the same as a spiral direction of the grooves during rotation of the shaft.

Other advantages and novel features of the present invention will become more apparent from the following detailed description of preferred embodiment when taken in conjunction with the accompanying drawings, in which:

### BRIEF DESCRIPTION OF THE DRAWINGS

Many aspects of the present bearing assembly for cooling fan can be better understood with reference to the following drawings. The components in the drawings are not necessarily drawn to scale, the emphasis instead being placed upon clearly illustrating the principles of the present bearing assembly. Moreover, in the drawings, like reference numerals designate corresponding parts throughout the several views.

FIG. 1 is an isometric, exploded view of a bearing assembly in accordance with a preferred embodiment of the present invention being used in a cooling fan;

FIG. 2 is an isometric, assembled view of the cooling fan of FIG. 1;

FIG. 3 is a cross sectional view of the cooling fan of FIG. 2;

FIG. 4 is an enlarged view of a circled portion IV of FIG. 3; and

FIG. 5 is an enlarged view of a rotary shaft of the bearing assembly.

### DETAILED DESCRIPTION OF THE INVENTION

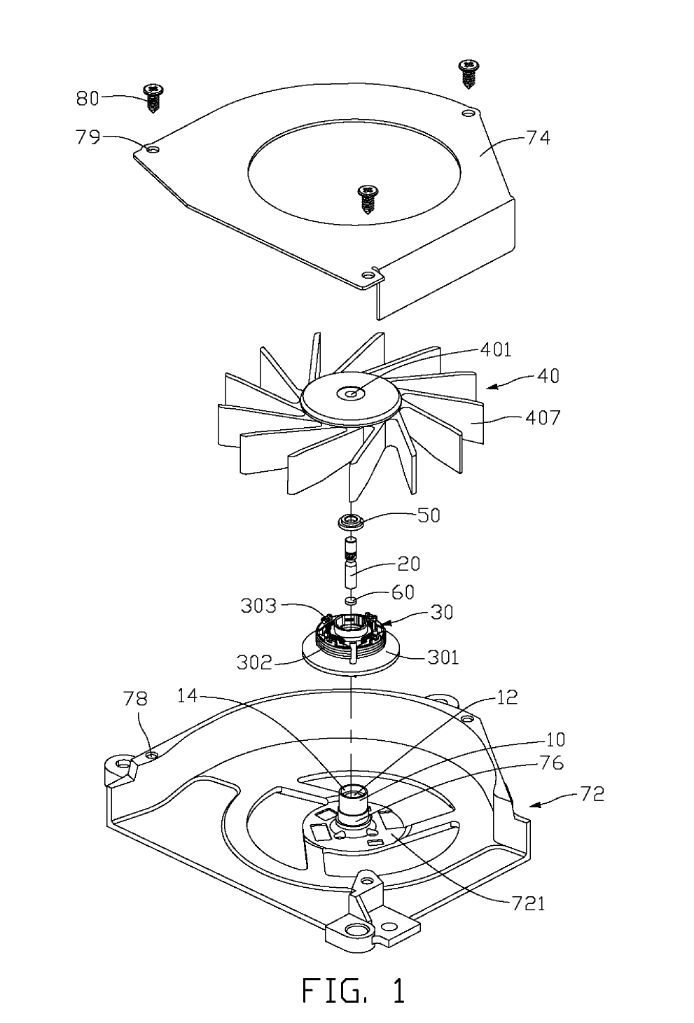

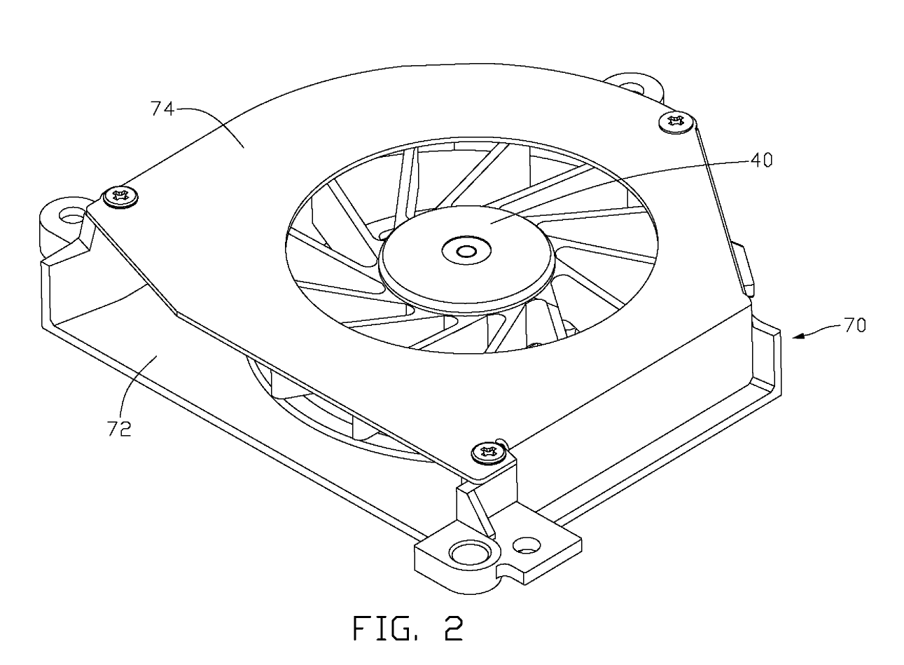

Referring to FIGS. 1-2, a bearing assembly according to a preferred embodiment of the present invention is shown. The bearing assembly can be used in a rotary motor, such as a fan motor or an HDD (hard disk drive) motor. In this embodiment, the bearing assembly is used in a fan motor of a cooling fan.

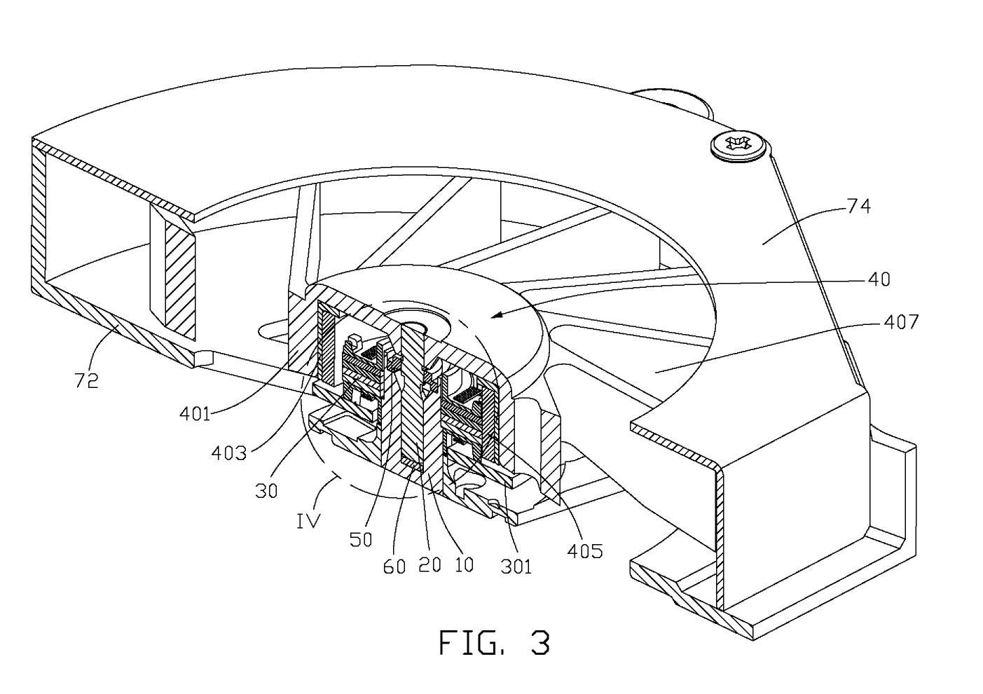

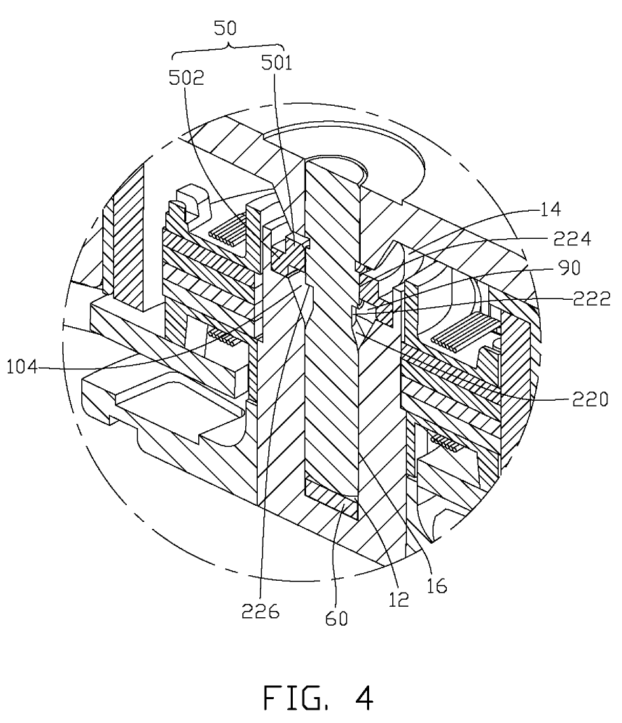

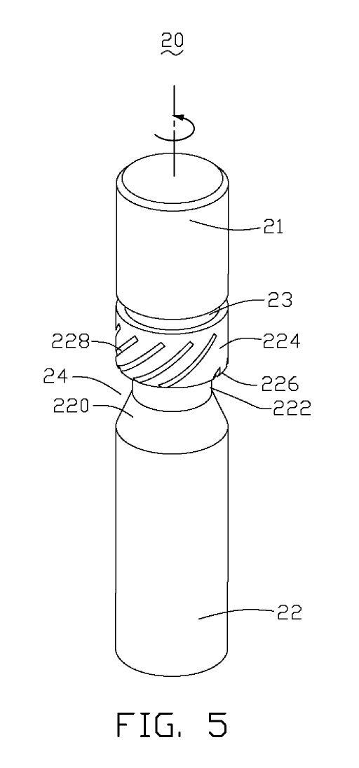

As shown in FIGS. 3-4, the bearing assembly includes a bearing 10 impregnated with lubricant, such as lubricating oil or lubricating grease. The bearing 10 has a generally U-shaped cross section with a bottom end thereof being closed and a top end thereof being open. The bearing 10 has a bearing surface 16 to define a bearing hole 12 therein. A shaft 20 is rotatably inserted into the bearing hole 12 through the open end of the bearing 10. A cover 50 is mounted around the shaft 20 and attaches to the open end of the bearing 10. A thrust washer 60 is disposed at a bottom of the bearing hole 12 for axially supporting the shaft 20. The thrust washer 60 consists of resin material or the like having high lubricity, so as to reduce the friction against a bottom end 22 (FIG. 5) of the shaft 20. The bearing 10 defines at the open end thereof an end opening 14 that is greater than the bearing hole 12 in diameter. A tapered surface 104 is formed on an inner-periphery of the bearing 10 between the bearing surface 16 and the end opening 14 of the bearing 10. The tapered surface 104 of the bearing 10 contracts radially from the end opening 14 to the bearing hole 12.

The cover 50 consists of plastic material having good resiliency, such as nylon. The cover 50 includes a generally annular body 501 having a center hole (not labeled) for allowing the shaft 20 to extend therethrough, and an annular flange 502 extending downwardly therefrom. Inner and outer surfaces of the cover 50 are step-shaped. An inner diameter of the body 501 of the cover 50 is larger than a diameter of the shaft 20, and an outer diameter of the cover 50 is smaller than the diameter of the end opening 14 of the bearing 10. An inner diameter of the flange 502 is larger than the diameter of the shaft 20, and an outer diameter of the flange 502 is approximately the same as the diameter of the end opening 14 of the bearing 10. A height of the cover 50 is approximately the same as a depth of the end opening 14 of the bearing 10.

Referring to FIG. 5, the shaft 20 is approximately column-shaped. A bottom end 22 is received in the bearing hole 12 of the bearing 10. An annular slot 23 is defined in the shaft 20 near the top end 21 thereof. The shaft 20 defines an annular notch 24 approximately at a middle of the shaft 20. A lubricant section 224 is thus formed on the shaft 20 between the notch 24 and the slot 23. A plurality of spiral grooves 228 are defined in the lubricant section 224. The grooves 228 are evenly arranged along a circumferential direction of the shaft 20. The spiral direction of the grooves 228 is the same as a rotary direction of the shaft 20 during operation of the cooling fan. In this embodiment, the grooves 288 have right hand thread, and the shaft 20 rotates anti-clockwise during operation. Alternatively, assuming the shaft 20 rotates clockwise, the grooves 288 should have left hand thread. The grooves 228 are spaced from the slot 23 and a distance is defined between top ends of the grooves 228 and the slot 23. The bottom ends of the grooves 228 extend through the lubricant section 224 and communicate with the notch 24. The position of the notch 24 is located corresponding to the position of the tapered surface 104 of the bearing 10. The shaft 20 forms a cylinder 222 that is smaller than other portion of the shaft 20 in diameter and located corresponding to an upper portion of the notch 24, and a tapered surface 220 expanding radially and extending downwardly from the cylinder 222. The tapered surface 220 is located corresponding to a lower portion of the notch 24. The cylinder 222 is orientated perpendicular to a bottom surface 226 of the lubricant section 224 of the shaft 20.

Also referring to FIGS. 1 -3, the cooling fan includes a housing 70 having a base 72 and a cover board 74 mounted on the base 72. Fixing holes 78, 79 are defined in the base 72 and the cover board 74, respectively, for extension of the screws 80 therethrough to lock the cover board 74 with the base 72. Cooperatively the base 72 and the cover board 74 define a space (not labeled) receiving the bearing assembly therein. A central tube 76 extends upwardly from a central portion of the base 72. A mounting hole (not labeled) is defined in the central tube 76 for receiving the bearing 10 therein. A stator 30 is mounted around the bearing 10. The stator 30 includes a stator core 302 with coil 303 wound thereon, and a circuit board 301 electrically connected to the coil 303. An impeller 40 is fixed to the shaft 20 at the top end 21 adjacent to the slot 23, to drive the shaft 20 into rotation relative to the bearing 10. The impeller 40 includes a hub 401 connected with the shaft 20 at a central portion thereof, a plurality of fan blades 407 radially extending from an outer periphery of the hub 401. An annular shell 403 adheres to an inner wall of the hub 401 and is disposed around the top end 21 of the shaft 20, and an annular permanent magnet 405 adheres to inner-periphery of the shell 403 to generating a permanent magnetic field.

During assembly, the shaft 20 is inserted into the bearing hole 12 through the open end of the bearing 10. The bottom end 22 of the shaft 20 abuts against the thrust washer 60 which is received in the bottom of the bearing hole 12. The notch 24 of the bearing 10 is located corresponding to the position of the tapered surface 104 of the bearing 10. The lubricant section 224 of the shaft 20 is located corresponding to the end opening 14 of the bearing 10 which is above the bearing hole 12. The cover 50 is mounted around the lubricant section 224 of the shaft 20. A narrow clearance of only 1˜5 μm is formed between an inner surface of the body 501 of the cover 50 and an outer surface of the shaft 20. The end opening 14 of the bearing 10 receives the cover 50 therein. A top surface of the cover 50 and a top surface of the lubricant section 224 of the shaft 20 are approximately coplanar. An oil-retaining space 90 is thus formed among the outer surface of the shaft 20 corresponding to the portion of the notch 24, the tapered surface 104 of the bearing 10 and the cover 50 for temporarily retaining escaping lubricant therein. Then the bearing assembly is mounted into the central tube 76 of the housing 70. The stator 30 is mounted around the bearing 10, and the impeller 40 is fixed to the top end 21 of the shaft 20.

During operation, a current is applied to the coil 303 of the stator 30 to establish an alternating magnetic field. The alternating magnetic field of the stator 30 interacts with the magnetic field of the permanent magnet 405 of the impeller 40 to drive the impeller 40 to rotate. The shaft 20 fixed to the impeller 40 is thus driven to rotate along with the impeller 40. The lubricant contained in the bearing assembly creeps up along the rotating shaft 20 under the influence of the centrifugal force generated by the rotation of the shaft 20. The notch 24 of the shaft 20 prevents most of the lubricant from creeping up along the shaft 20 and thus most of the lubricant is received in the oil-retaining space 90 temporarily. The remaining lubricant flows up into the grooves 228 of the lubricant section 224 of the shaft 20, and is driven with the rotating shaft 20 due to the mobility of the lubricant. The remainder lubricant thus moves toward the middle of the shaft 20 along the grooves 228 for the same directions of the spiral direction of the grooves 228 and the rotation direction of the shaft 20. The cover 50 also can prevent the remaining lubricant from leakage out of the bearing assembly. Thus, for the most part, the lubricant is kept from leaking out of the bearing assembly. The lubricant then flows back and is received in the oil-retaining space 90 temporarily, and finally flows back to the bearing assembly. Good lubrication of the bearing 10 and shaft 20 is thus consistently maintained, thereby improving the quality and life-span of the cooling fan.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A bearing assembly comprising:
a bearing having an open end and a bearing surface defining a bearing hole therein; and
a shaft being rotatably inserted into the bearing hole through the open end along an axial direction of the bearing, the shaft defining a notch in an outer periphery thereof, which is located corresponding to the open end of the bearing, a plurality of spiral grooves being defined in the outer periphery of the shaft above the notch along a direction opposite to an inserting direction of the shaft, wherein during rotation the shaft has a rotation direction in same direction as spiral direction of the grooves.

2. The bearing assembly as described in claim 1, wherein the notch communicates with the grooves.

3. The bearing assembly as described in claim 1, wherein the notch of the shaft is located inside the bearing hole, and the grooves of the shaft are located outside the bearing hole.

4. The bearing assembly as described in claim 1, wherein the shaft forms a cylinder located corresponding to an upper portion of the notch and a tapered surface located corresponding to a lower portion of the notch, the tapered surface of the shaft expanding radially along the inserting direction of the shaft.

5. The bearing assembly as described in claim 4, wherein a cover is mounted around the shaft and is located corresponding to the grooves of the shaft.

6. The bearing assembly as described in claim 5, wherein the bearing defines an end opening in the open end thereof that is greater than the bearing hole in diameter, the cover being received in the end opening with an outer periphery thereof abutting the open end of the bearing.

7. The bearing assembly as described in claim 6, wherein a tapered surface is formed on an inner-periphery of the bearing between the bearing surface and the end opening of the bearing, the tapered surface of the bearing being located corresponding to the notch of the shaft.

8. The bearing assembly as described in claim 6, wherein the cover has an annular flange extending perpendicularly therefrom, an inner diameter of the flange being larger than a diameter of the shaft, and an outer diameter of the flange being approximately the same as a diameter of the end opening of the bearing.

9. The bearing assembly as described in claim 5, wherein a top surface of the cover is higher than top ends of the grooves.

10. The bearing assembly as described in claim 1, wherein the bearing is U-shaped with a closed end opposite to the open end.

11. A motor comprising:
a housing having a tube extending upwardly therefrom;
a bearing being received in the tube of the housing and defining a bearing hole therein;
a shaft being rotatably disposed in the bearing hole with a first end inside in the bearing hole and a second end outside the bearing hole, the shaft defining a notch near the second end thereof, and a plurality of spiral grooves communicating with the notch and being defined in the shaft above the notch along a direction from the first end to the second end, the notch communicates with the grooves;
a stator being mounted around the bearing, a coil being wound on the stator for establishing an alternating magnetic field when an electric current is applied thereto; and
an impeller being fixed to the second end of the shaft, the impeller having a permanent magnet for establish magnetic field which interacts with the alternating magnetic field of the coil to drive the shaft into rotation.

12. The bearing assembly as described in claim 11, wherein the notch of the shaft is located inside the bearing hole, and the grooves of the shaft are located outside the bearing hole.

13. The motor as described in claim 11, wherein the shaft forms a cylinder located corresponding to an upper portion of the notch and a tapered surface located corresponding to a lower portion of the notch, the tapered surface of the shaft expanding radially along a direction from the second end to the first end of the shaft.

14. The motor as described in claim 11, further comprising a cover mounted around the shaft and being located corresponding the grooves of the shaft.

15. The motor as described in claim 11, wherein a rotation direction of the shaft is the same as a spiral direction of the grooves during rotation of the shaft.
